(19) United States
(12) Patent Application Publication
(10) Pub. No.: US 2026/0127758 A1
(43) Pub. Date: May 7, 2026

(54) METHOD AND APPARATUS FOR TRAINING POSE ESTIMATION MODEL, ELECTRONIC DEVICE, AND STORAGE MEDIUM

(71) Applicant: Tencent Technology (Shenzhen) Company Limited, Shenzhen (CN)

(72) Inventors: Yingyi ZHANG, Shenzhen (CN); Ruixin ZHANG, Shenzhen (CN); Shouhong DING, Shenzhen (CN)

(21) Appl. No.: 19/440,379

(22) Filed: Jan. 5, 2026

Related U.S. Application Data
(63) Continuation of application No. PCT/CN2024/123387, filed on Oct. 8, 2024.

(30) Foreign Application Priority Data
Oct. 23, 2023 (CN) 202311370780.4

(51) Int. Cl. G06T 7/73

(52) U.S. Cl. CPC G06T 7/73; G06T 2207/20081; G06T 2207/20084

(57) ABSTRACT

This application relates to a method for training a pose estimation model performed by an electronic device. The method includes: acquiring a sample image and first coordinates of a preset key point in the sample image; estimating a pose of an object in the sample image through an initial pose estimation model, to obtain predicted second coordinates of the preset key point and L groups of predicted parameter values for preset L distribution functions respectively; aggregating the L distribution functions to obtain a predicted probability distribution that a predicted pixel point in the sample image is the preset key point; determining a distribution loss according to a difference between the predicted probability distribution and a target probability distribution based on the first coordinates; and adjusting a model parameter of the initial pose estimation model based on the distribution loss, to obtain a target pose estimation model.

### CROSS-REFERENCE TO RELATED APPLICATIONS

This application is a continuation application of PCT Patent Application No. PCT/CN2024/123387, entitled “METHOD AND APPARATUS FOR TRAINING POSE ESTIMATION MODEL, ELECTRONIC DEVICE, AND STORAGE MEDIUM” filed on Oct. 8, 2024, which claims the priority to Chinese Patent Application No. 202311370780.4, entitled “METHOD AND APPARATUS FOR TRAINING POSE ESTIMATION MODEL, ELECTRONIC DEVICE, AND STORAGE MEDIUM” filed on Oct. 23, 2023, all of which is incorporated herein by reference in their entirety.

### FIELD OF THE TECHNOLOGY

This application relates to the technical field of data treatment, and in particular, to a method and apparatus for training a pose estimation model, an electronic device, and a storage medium.

### BACKGROUND OF THE DISCLOSURE

With the development of artificial intelligence technologies, a post of an object in a to-be-recognized image can be estimated by virtue of a pose estimation model, to obtain coordinate information of key points for describing the pose of the object. Further, the pose of the object can be estimated through the obtained coordinate information.

In the related art, during training of the pose estimation model, it is difficult to capture intrinsic information of an inputted sample image, and a training effect of the pose estimation model cannot be ensured. Further, when a pose of an object in an image is estimated by virtue of a trained pose estimation model, coordinate information of key points of the object cannot be accurately obtained, and thus an effect of pose estimation is reduced.

### SUMMARY

A method and apparatus for training a pose estimation model, an electronic device, and a storage medium are provided in embodiments of this application. Thus, the accuracy of pose estimation of the pose estimation model is improved.

According to the embodiments of this application, a method for training a pose estimation model performed by an electronic device includes:
acquiring a sample image and first coordinates of a preset key point in the sample image, and the preset key point being configured for locating a pose of an object in the sample image;
estimating the pose of the object in the sample image through an initial pose estimation model, to obtain predicted second coordinates of the preset key point in the sample image and L groups of predicted parameter values for preset L distribution functions respectively;
aggregating the L distribution functions based on the predicted second coordinates and the L groups of predicted parameter values, to obtain a predicted probability distribution that a predicted pixel point in the sample image is the preset key point;
determining a distribution loss according to a difference between the predicted probability distribution and a target probability distribution based on the first coordinates; and
adjusting a model parameter of the initial pose estimation model based on the distribution loss, to obtain a target pose estimation model.

According to the embodiments of this application, an electronic device is provided. The electronic device includes a memory, a processor, and a computer program stored in the memory and runnable in the processor, the processor, when executing the computer program, causing the electronic device to implement the foregoing method.

According to the embodiments of this application, a non-transitory computer-readable storage medium is further provided. The computer-readable storage medium has a computer program stored therein, the computer program, when executed by a processor of an electronic device, causing the electronic device to implement the foregoing method.

### BRIEF DESCRIPTION OF THE DRAWINGS

FIG. 1 is a schematic diagram of a possible application scenario in an embodiment of this application.

FIG. 2A is a schematic diagram of a process of training a pose estimation model in an embodiment of this application.

FIG. 2B is another schematic diagram of a process of training a pose estimation model in an embodiment of this application.

FIG. 3 is a schematic diagram of an outputted result of an initial pose estimation model in an embodiment of this application.

FIG. 4A is a schematic diagram of a process of determining a corresponding predicted probability distribution for one preset key point in an embodiment of this application.

FIG. 4B is a schematic diagram of a mapping relationship between a predicted probability distribution and a sample image in an embodiment of this application.

FIG. 4C is a schematic diagram of dynamic adjustment of a target probability distribution in an embodiment of this application.

FIG. 4D is a schematic diagram of a process of calculating a model loss for a preset key point in an embodiment of this application.

FIG. 5A is a schematic diagram of a process of implementing service treatment by virtue of a target pose estimation model in an embodiment of this application.

FIG. 5B is a schematic diagram of a process of obtaining a to-be-treated image through arrangement in an embodiment of this application.

FIG. 5C is a schematic diagram of a process of pose estimation in an embodiment of this application.

FIG. 6A is a schematic diagram of a flow of palmprint recognition in an embodiment of this application.

FIG. 6B is a schematic diagram of treatment logic during action recognition by virtue of a target pose estimation model in an embodiment of this application.

FIG. 7 is a schematic structural diagram of logic of an apparatus for training a pose estimation model in an embodiment of this application.

FIG. 8 is a schematic structural diagram of hardware components of an electronic device in an embodiment of this application.

### DESCRIPTION OF EMBODIMENTS

To make the objectives, technical solutions, and advantages in embodiments of this application clearer, the technical solutions of this application are clearly and completely described below with reference to the accompanying drawings in the embodiments of this application. Apparently, the described embodiments are some embodiments rather than all embodiments of the technical solutions of this application. All other embodiments derived by those of ordinary skill in the art based on the embodiments described in the file of this application without creative efforts fall within the scope of protection of the technical solutions of this application.

The terms “first”, “second”, etc. in the description and the claims of this application and the above accompanying drawings are used for distinguishing between similar objects, and not necessarily used for describing a particular order or successive sequence. The data used in this way are exchangeable where appropriate, so that the embodiments of the present disclosure described herein can be implemented in an order different from those shown or described herein.

Some terms in the embodiments of this application are explained below to facilitate understanding of those skilled in the art.

The physical detection is to determine a region of a physical body from an image through a target detection technology, so that a physical region image can be extracted from the image. The image can be replaced with a picture. The image can be an image frame in a video. The video can be pre-collected or collected in real time.

The hand detection is to locate a region of a hand from an image through a target detection technology, so that a hand region image can be extracted from the image.

The key point can include a connection point and/or a joint point of a physical skeleton, for example, a head, a shoulder, an elbow, a wrist, a hip, a knee, and an ankle, and can further include a particular point on a physical part, for example, a point on a face or a hand.

The physical pose estimation is to estimate coordinates of key points of a physical skeleton in various poses in an image. The physical pose estimation generally includes pose estimation of an entire physical body and pose estimation of local limbs. The physical pose estimation, a basic task in computer vision, is intended to predict position information of a pre-defined key point (or referred to as a preset key point) on a physical body in an image and is widely applied to various visual tasks. The physical pose estimation is an important pre-treatment operation of various downstream tasks (such as physical motion analysis, activity recognition, and action capture). The physical pose estimation is also defined as searching for a particular pose in a space formed by all joint poses.

The hand pose estimation is to estimate coordinates of key points of a hand skeleton in various poses in an image. The hand pose estimation, a basic task in computer vision, is intended to predict position information of a pre-defined key point (or referred to as a preset key point) of a hand in an image and is widely applied to various visual tasks. The hand pose estimation is an important pre-treatment operation of various downstream tasks (such as gesture recognition, hand motion analysis, and action capture).

The regression based pose estimation is to output coordinates of key points through a pose estimation model in a regressive mode for an inputted image in the embodiments of this application. The pose estimation model can be an initial pose estimation model configured for model training or a target pose estimation model finally obtained through model training. The regression based pose estimation is to denote a position of a joint point in a form of two-dimensional coordinates, etc., and train a network by learning mapping from a physical feature to a position of a physical part, so that the network directly outputs coordinates of each joint point, and further estimates a physical pose.

The linear layer indicates a layer that performs linear transformation on input in a neural network. In deep learning, a neural network generally includes a plurality of layers, and each layer is responsible for executing a particular task. These layers include, for example, a pooling layer, a linear layer, and an activation function layer. For example, the linear layer is configured for multiplying inputted data by a weight matrix and adding a bias item, to generate output.

The probability distribution indicates that a value of each point (for example, a pixel position in an image) indicates a probability corresponding to the point for a distribution of 1 in total. In other words, the probability distribution indicates a probability that a random variable is set as a particular value.

The Gaussian mixture model is a probability distribution model formed by linear combinations of a plurality of Gaussian distribution functions.

The Monte Carlo estimation is a method for calculating an approximate value through random sampling from a probability model.

The Pearson correlation coefficient is configured for measuring a correlation degree between two variables and is set between −1 and 1.

The heatmap based pose estimation indicates that for an inputted image, a model outputs a corresponding heatmap to generate coordinates of key points.

The argmax function is configured for acquiring an array subscript corresponding to a maximum element in an inputted array.

In a process of selecting the way to implement pose estimation, the applicant conceives that assuming that treatment is performed through a heatmap based pose estimation technology, a high-resolution likelihood heatmap needs to be generated based on a feature map. In the heatmap, a position deemed by the model to be most likely to have a key point is marked with a high probability, and other positions are marked with a low probability. Based on the heatmap, coordinates of the key points predicted by the model are acquired according to the argmax function. However, in the heatmap based pose estimation solution, a prediction end generates a high-resolution likelihood heatmap according to an inputted feature map. A number of the heatmaps equals a number of to-be-predicted key points, so that one heatmap is generated in correspondence to each key point. Undoubtedly, a large quantity of internal memories are occupied in this way, and a high calculation cost is generated. In consequence, it is difficult to apply the solution to a real-time scenario having a high requirement on a speed and an Internet of Things device having limited calculation resources. Moreover, due to a limited size of the heatmap, the coordinates of the key points acquired according to the argmax function generally include quantization errors. This also affects final performance of the model.

In view of the above, to occupy fewer internal memory resources and calculation resources in the process of pose estimation, the applicant conceives that the treatment can be performed by virtue of a conventional technology of regression based pose estimation.

Thus, assuming that the treatment is performed by virtue of the conventional technology of regression based pose estimation, during the treatment, features are simplified through global average pooling. The prediction end includes only several linear layers, and outputs predicted coordinates of the key points directly in a regressive mode.

However, in the conventional technical solution of regression based pose estimation, coordinate values (vectors) directly regressed and an inputted image are not located in the same spatial dimension. To be specific, because outputted coordinate values correspond to one specific point while one image is inputted, the coordinate values and the inputted image do not belong to the same spatial dimension. Thus, in a process of model training, the coordinate value constraint is a type of implicit and non-alignment constraint, the model cannot well capture internal information of an inputted image, and an effect of model training is undesirable.

In view of the above, this application provides a method and apparatus for training a pose estimation model, an electronic device, and a storage medium.

In a process of training a regression based initial pose estimation model, an outputted result of the initial pose estimation model is adjusted, so that based on outputting predicted coordinates corresponding to each preset key point through regression treatment, L groups of predicted parameter values corresponding to each predicted key point are additionally outputted. Thus, a treatment basis is provided for a process of parameter concretization and aggregation of L distribution functions for each preset key point.

Also, in a process of establishing a constraint for model training, a predicted probability distribution corresponding to each preset key point is constructed. Thus, the predicted coordinates for the preset key point can be converted into a probability distribution on a corresponding sample image by aggregating the L distribution functions for each preset key point. Thus, the image inputted into the initial pose estimation model and the predicted probability distribution according to which the constraint is established for the initial pose estimation model are located in the same dimension. In this way, a target pose estimation model obtained through training better captures the intrinsic information of the image, so that an expression capability of the target pose estimation model is improved. Thus, key point location and pose estimation of an object in the image are more accurate. Moreover, the target pose estimation model is endowed with better treatment performance.

In addition, in combination with the lightweight network feature of a regression based network structure, in a process of obtaining the target pose estimation model by training the initial pose estimation model, the performance of pose estimation of the model can be ensured, and the accuracy of pose estimation can be improved. Moreover, fewer internal memory resources and calculation resources are occupied, a time-consuming burden is reduced, and a resource utilization rate is increased.

The embodiments of this application are described below with reference to the accompanying drawings in the description. The embodiments described herein are merely for describing and explaining this application, and are not for limiting this application. All the embodiments (including the embodiments in the claims and the embodiments in the description) of this application and features in the embodiments can be combined with one another in different manners to form other embodiments without conflict.

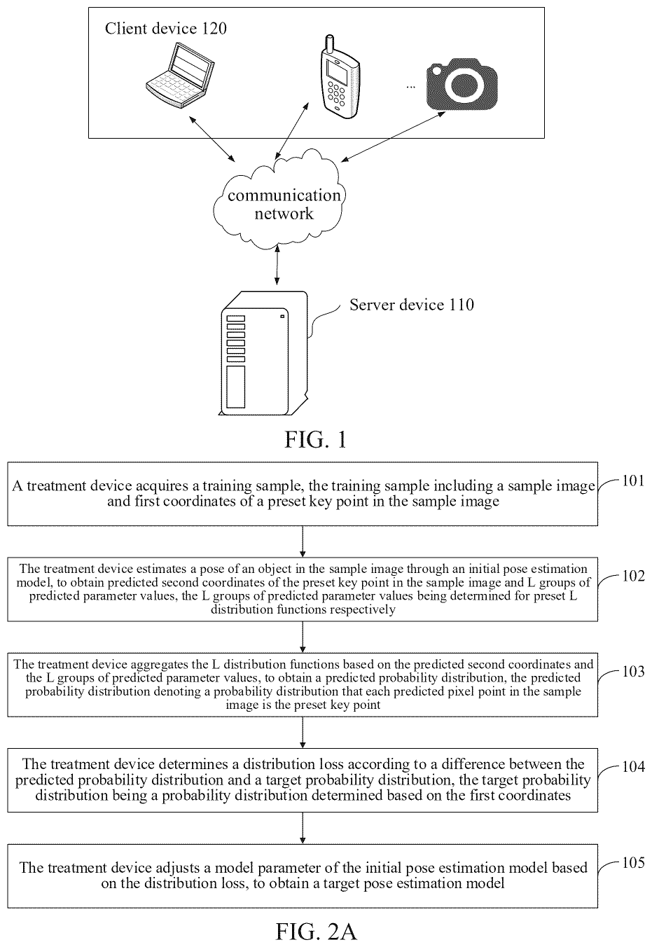

With reference to FIG. 1, a schematic diagram of a possible application scenario in an embodiment of this application is shown in FIG. 1. A server device 110 and a client device 120 are involved in the schematic diagram of the application scenario.

In some feasible embodiments of this application, a target pose estimation model may be obtained through training by the server device 110. Further, the server device 110 may automatically implement a pose estimation task in a specific pose estimation scenario. Alternatively, the server device 110 may transmit a trained target pose estimation model to the client device 120, so that the client device 120 may implement a pose estimation task in a specific pose estimation scenario.

Alternatively, in some other feasible embodiments, a target pose recognition model may be obtained through training by the client device 120, to implement a pose estimation task in a specific pose estimation scenario.

The server device 110 may be an independent physical server, a server cluster or distributed system including a plurality of physical servers, or a cloud server providing a basic cloud calculation service such as a cloud service, a cloud database, cloud calculation, a cloud function, cloud storage, a network service, cloud communication, a middleware service, a domain name service, a security service, a content delivery network (CDN), big data, and an artificial intelligence platform.

The client device 120 includes, but is not limited to, a smartphone, a tablet computer, a notebook computer, an ebook reader, an intelligent voice interaction device, an intelligent appliance, an in-vehicle terminal, an aircraft, etc. The embodiments of this application may be applied to various scenarios, including, but not limited to, a cloud technology, artificial intelligence, intelligent traffic, assisted driving, etc.

In the feasible embodiments of this application, a related object may initiate, on the client device 120, a pose estimation request for a to-be-treated image by virtue of a target application. Thus, a treatment device implementing pose estimation may perform pose estimation treatment on the to-be-treated image, to obtain a pose estimation result. The target application may be a mini program application, a client application, or a web application. The treatment device may be specifically the server device 110 or the client device 120, which is not specifically limited in this application.

In the embodiments of this application, communication between the server device 110 and the client device 120 may be performed through a wired network or a wireless network. A related treatment process is illustratively described below with the treatment device implementing training of the target pose estimation model and the pose estimation task as an example. According to the actual treatment demand, the treatment device may specifically indicate the server device 110 or the client device 120.

The scenarios related to pose estimation are described below with reference to several possible application scenarios.

Scenario 1, a to-be-recognized region is located in a process of identity recognition.

In an application scenario of the scenario 1, recognition information to be used for identity recognition may be first determined. Further, each preset key point to be estimated in an image during pose estimation is determined according to the recognition information to be used. For example, assuming that the identity recognition is performed by virtue of a palmprint, at least a hand region in the image may be located through each preset key point determined. For another example, assuming that the identity recognition is performed by virtue of an iris, at least an eye region in the image may be located through each preset key point determined. For yet another example, assuming that the identity recognition is performed by virtue of a gesture, at least different gestures may be determined through each preset key point determined.

After the target pose estimation model is obtained through training by the treatment device, coordinate information of each predicted key point may be outputted based on the to-be-recognized image by virtue of the target pose estimation model. Further, a region to be recognized during the identity recognition may be determined by virtue of each coordinate information, and then a to-be-recognized region is clipped from the to-be-recognized image.

Scenario 2, action recognition is performed in a process of abnormality detection.

In an application scenario of the scenario 2, an object targeted by the action recognition may be first determined. The object targeted by the action recognition may be a living person or animal, or a nonliving product that presents different actions with mechanical motion. Further, each preset key point configured for locating a pose may be determined for the object targeted by the action recognition. Then, each training sample is created in a targeted mode, and the target pose estimation model is obtained through training by virtue of each training sample. Next, a region of a to-be-recognized object may be first detected from a shot original image through a target detection technology. Then, the to-be-recognized image encompassing the region of the to-be-recognized object is clipped from the original image. Finally, a pose of the object in the to-be-recognized image is estimated through the target pose estimation model, and predicted coordinates corresponding to each preset key point are determined. Then, an abnormal action (such as falling) is recognized according to each predicted coordinate.

Scenario 3, action recognition is performed in a process of action teaching.

In an application scenario corresponding to the scenario 3, an object targeted by the action recognition may be first determined. The object targeted by the action recognition may be a “person”. Further, for the object targeted by the action recognition, each preset key point configured for locating a pose is determined. Each training sample is created in a targeted mode. A target pose estimation model is obtained through training by virtue of the training sample.

Next, a region of a to-be-recognized object is detected from a shot original image through the target detection technology. Then, a to-be-recognized image encompassing the region of the to-be-recognized object is clipped from the original image. Finally, pose estimation is performed on the to-be-recognized image (an object in the to-be-recognized image) through the target pose estimation model, and predicted coordinates corresponding to each preset key point are determined. Then, tasks such as dance action recognition and dance gait recognition are implemented according to each predicted coordinate.

Also, acquisition and treatment of a sample image and a to-be-treated image are involved in a particular implementation of this application. When the embodiments described in this application are applied to a specific product or technology, permission or consent of a related object needs to be obtained, and collection, use, and treatment of related data need to comply with relevant laws, regulations, and standards of relevant countries and regions.

A process of training a pose estimation model is first described below with reference to the accompanying drawings from the perspective of a treatment device.

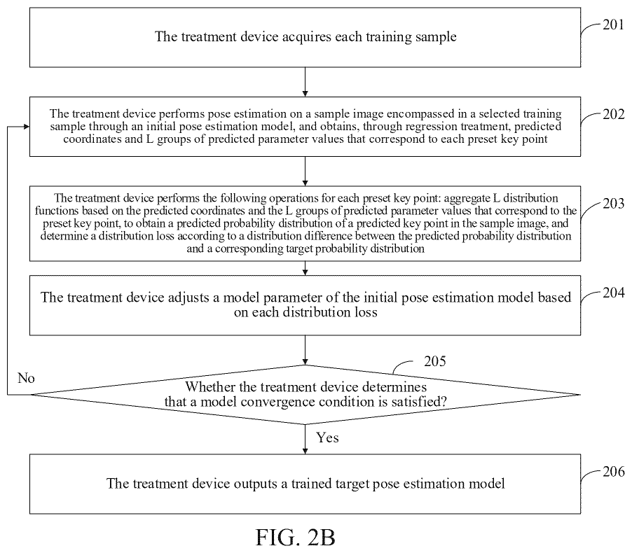

With reference to FIG. 2A, a schematic diagram of a process of training a pose estimation model in an embodiment of this application is shown in FIG. 2A. As shown in FIG. 2A, the process includes the following operations 101 to 105.

Operation 101, a treatment device may acquire a training sample, the training sample including a sample image and first coordinates of a preset key point in the sample image, and the preset key point being configured for locating a pose of an object in the sample image. The “first coordinates” are coordinates in the “sample image”, and thus may alternatively be referred to as “sample coordinates”. In all the embodiments of this application, the descriptions about the “sample coordinates” are also the descriptions about the “first coordinates”. The first coordinates/sample coordinates may be manually marked.

Operation 102, the treatment device estimates the pose of the object in the sample image through an initial pose estimation model, to obtain predicted second coordinates of the preset key point in the sample image and L groups of predicted parameter values, the L groups of predicted parameter values being determined for preset L distribution functions respectively. The “predicted second coordinates” are coordinates of the preset key point predicted through the initial pose estimation model, and thus may alternatively be referred to as “predicted coordinates”. In all the embodiments of this application, the descriptions about the “predicted coordinates” are also the descriptions about the “predicted second coordinates”.

Operation 103, the treatment device aggregates the L distribution functions based on the predicted second coordinates and the L groups of predicted parameter values, to obtain a predicted probability distribution, the predicted probability distribution denoting a probability distribution that each predicted pixel point in the sample image is the preset key point.

Operation 104, the treatment device determines a distribution loss according to a difference between the predicted probability distribution and a target probability distribution, the target probability distribution being a probability distribution determined based on the first coordinates.

Operation 105, the treatment device adjusts a model parameter of the initial pose estimation model based on the distribution loss, to obtain a target pose estimation model.

According to the embodiment of this application, the aggregating in operation 103 may include: perform parameter assignment and weighted summation on the L distribution functions based on the predicted second coordinates and the L groups of predicted parameter values, to obtain the predicted probability distribution. More specifically, the aggregating may include: perform parameter assignment on each distribution function corresponding to the L distribution functions based on the predicted second coordinates and a predicted function parameter value in each group of predicted parameter values of the L groups of predicted parameter values, and obtain L distribution function results; and take the L distribution function results as components, and perform weighted summation on the L distribution function results through a component weight of the L groups of predicted parameter values, to obtain the predicted probability distribution.

When the preset L distribution functions are L Gaussian distributions, the aggregating may include: determine a mean matrix of each Gaussian distribution of the L Gaussian distributions based on the predicted second coordinates, determine a covariance matrix and a component weight of the Gaussian distribution based on one group of predicted parameter values corresponding to the Gaussian distribution, and obtain a Gaussian distribution result after the parameter assignment; and perform Gaussian mixture treatment on the L Gaussian distribution results according to component weights determined for the L Gaussian distributions respectively, to obtain the predicted probability distribution.

The target probability distribution may be one Gaussian distribution and is determined in the following mode: determine a target mean matrix based on the first coordinates, determine a standard deviation on a horizontal coordinate axis and a standard deviation on a vertical coordinate axis in an image coordinate system respectively, and determine a target covariance matrix of the target probability distribution according to the standard deviation on the horizontal coordinate axis and the standard deviation on the vertical coordinate axis; and perform parameter assignment on a standard Gaussian distribution based on the target mean matrix and the target covariance matrix, and obtain the target probability distribution.

The determining of the standard deviation on the horizontal coordinate axis and the standard deviation on the vertical coordinate axis respectively may include: determine, based on the first coordinates and the predicted second coordinates, a norm value indicating a difference between the first coordinates and the predicted second coordinates; and determine, when it is determined that the norm value exceeds a set threshold, the norm value as the standard deviation on the horizontal coordinate axis and the standard deviation on the vertical coordinate axis of the target probability distribution, and determine, when it is determined that the norm value does not exceed a set threshold, the set threshold as the standard deviation on the horizontal coordinate axis and the standard deviation on the vertical coordinate axis of the target probability distribution, the standard deviation on the horizontal coordinate axis and the standard deviation on the vertical coordinate axis of the target probability distribution being set as the same value.

Before operation 105, the method may further include: calculate a position loss based on the difference between the predicted second coordinates and the first coordinates, the position loss denoting a loss predicted by the initial pose estimation model for a coordinate position of the preset key point in the sample image; and the adjusting of the model parameter of the initial pose estimation model based on the distribution loss includes: adjust the model parameter of the initial pose estimation model based on the distribution loss and the position loss.

The initial pose estimation model includes a backbone and a prediction end, the prediction end including several linear layers. The estimating of the pose of the object in the sample image through the initial pose estimation model may include: extract a feature from the sample image through the backbone; and perform regression treatment on the feature extracted through the linear layer, and predict the second coordinates and the L groups of predicted parameter values.

After the target pose estimation model is obtained, the method may further include: acquire a to-be-treated image; and estimate a pose of a to-be-recognized object in the to-be-treated image through the target pose estimation model, and obtain coordinate information of the preset key point in the to-be-treated image.

The acquiring of the to-be-treated image includes: acquire an original image; recognize an object in the original image, and determine a target region encompassing the to-be-recognized object in the original image, the to-be-recognized object being an object targeted by pose estimation; and clip an image content corresponding to the target region from the original image, and obtain the to-be-treated image.

After the obtaining of the coordinate information of the preset key point in the to-be-treated image, the method further includes: determine a state feature of the to-be-recognized object in the to-be-treated image based on a position relationship between the coordinate information; and determine a target state matching the to-be-recognized object based on a matching condition between the state feature and a candidate state feature corresponding to each candidate state.

With reference to FIG. 2B, another schematic diagram of a process of training a pose estimation model in an embodiment of this application is shown in FIG. 2B. FIG. 2B may describe the process of training the pose estimation model shown in FIG. 2A in further details. A related process of model training is described below with reference to FIG. 2B.

Operation 201: The treatment device acquires each training sample.

In the embodiment of this application, to obtain the target pose estimation model through training, the treatment device acquires each training sample configured for the pose estimation demand. One training sample includes one sample image and sample coordinates of each preset key point in the sample image. Each preset key point is configured for locating a pose.

In the embodiment of this application, each preset key point may be selected according to the pose estimation demand. In a feasible embodiment, when a pose of a “person” is estimated, the preset key points may include general-purpose physical key points (or referred to as physical skeleton key points), or may include physical key points and other self-defined key points. When a pose of a local physical part is estimated, the preset key points may include key points in a local physical region. For example, when a gesture is recognized, the preset key points include general-purpose hand key points (including finger joint key points, etc.). In this way, for a specific pose estimation task, each preset key point is adaptively selected, so that poses of different objects can be effectively located.

Operation 202: The treatment device performs pose estimation on a sample image encompassed in a selected training sample through the initial pose estimation model, and obtains, through regression treatment, the predicted coordinates and the L groups of predicted parameter values that correspond to each preset key point.

In the embodiment of this application, output of a conventional regression based pose estimation network may be adjusted, to obtain the initial pose estimation model. The backbone in the initial pose estimation model may be any network that implements feature extraction in a pose estimation scenario, such as StemNet and a high-resolution network-W48 (HRNet-W48). The prediction end of the initial pose estimation model includes several linear layers, the prediction end being configured for implementing calculation and prediction functions.

For the conventional regression based pose estimation network, to-be-adjust contents include, for example, treatment and output of the linear layer of the prediction end. In view of the above, by adjusting the treatment and output of the linear layer, in a process of training the initial pose estimation model, the predicted coordinates may be outputted, and one group of predicted parameter values corresponding to each distribution function of the preset L distribution functions may be outputted. A number of output of the linear layers may be determined according to a number of the preset distribution functions and assignment of each distribution function. Also, in this application, an outputted content form may be set according to the actual treatment demand.

The initial pose estimation model is, for example, a neural network, and includes feature extraction and regression treatment. The feature extraction includes, for example, extracting a feature such as an edge, a texture, and a color in the sample image. A large number of such cases exist in the real world: two or more variables have particular relationships, but it cannot be definitely deemed that one variable can strictly determine another variable. A regression method is a type of prediction technology for studying a relationship between a dependent variable (a target) and an independent variable (a predictor) of such variables. For example, a linear regression method is used during the regression treatment. The predicted coordinates of the preset key point and the predicted parameter values for the L distribution functions are obtained by preforming linear transformation on the feature extracted.

Assuming that one group of predicted parameter values involve four parameters, which are a standard deviation on a horizontal axis, a standard deviation on a vertical axis, a Pearson correlation coefficient, and a component weight of a distribution function respectively, the Pearson correlation coefficient is configured for indicating a correlation between the standard deviation on the horizontal axis and the standard deviation on the vertical axis. Thus, in some embodiments, by adjusting the output of the linear layer, the predicted coordinates and four parameter vectors may be outputted in correspondence to each preset key point. When L denotes a total number of the preset distribution functions, each parameter vector includes L parameter values, and parameter values at the same positions in different parameter vectors form one group of predicted parameter values. Alternatively, in some other embodiments, by adjusting output of the linear layer, the predicted coordinates and L parameter vectors may be outputted in correspondence to each preset key point. Each parameter vector includes four parameter values, which are a standard deviation on a horizontal axis, a standard deviation on a vertical axis, a correlation coefficient, and a weight coefficient of the distribution function respectively. Alternatively, in yet some other embodiments, by adjusting output of the linear layer, the predicted coordinates and one parameter vector may be outputted in correspondence to each preset key point. The parameter vector includes 4*L parameter values. Every four parameter values starting from the first parameter value may be deemed as one group of predicted parameter values. The above horizontal axis and vertical axis are in the image coordinate system. The image coordinate system may take the lower left corner of the image as an origin, a length direction of the image as the vertical axis, and a width direction of the image as the horizontal axis. Sometimes, the “predicted parameter value” is alternatively referred to as the “predicted parameter”.

After acquiring each training sample and the initial pose estimation model constructed, the treatment device may perform one round of iterative training by selecting one training sample from the training samples.

In the embodiment of this application, the batch size may be determined according to the actual treatment demand. The related process of training is described below with the batch size set as 1 as an example. When the batch size is set to be greater than 1, a loss value may be determined for each sample image acquired. Further, the model parameter may be adjusted based on loss values determined in correspondence to different sample images respectively.

In the embodiment of this application, the treatment device selects a training sample used in a current round of iterative training from the training samples, to obtain a sample image used in the current round of iterative training. Then, the treatment device performs pose estimation on the sample image selected through the initial pose estimation model, and obtains, through the regression treatment, the predicted coordinates and the L groups of predicted parameter values that correspond to each preset key point, the L groups of predicted parameter values being determined for the preset L distribution functions respectively.

In the embodiment of this application, according to the actual treatment demand, types of the preset L distribution functions may be specifically any one or combinations of distribution functions having clear probability functions, such as a Gaussian distribution, a Laplace distribution, a Dirac distribution, and a polynomial distribution. This application is illustratively described with the preset L distribution functions being the L Gaussian distributions as an example.

An outputted result of the initial pose estimation model corresponds to a type of the distribution function selected. In other words, when different types of distribution functions are selected, parameters required to perform parameter assignment on the distribution functions are different. Thus, to satisfy the demand for assignment of the distribution function, at a stage of constructing the initial pose estimation model, outputted contents of the initial pose estimation model may be adaptively adjusted.

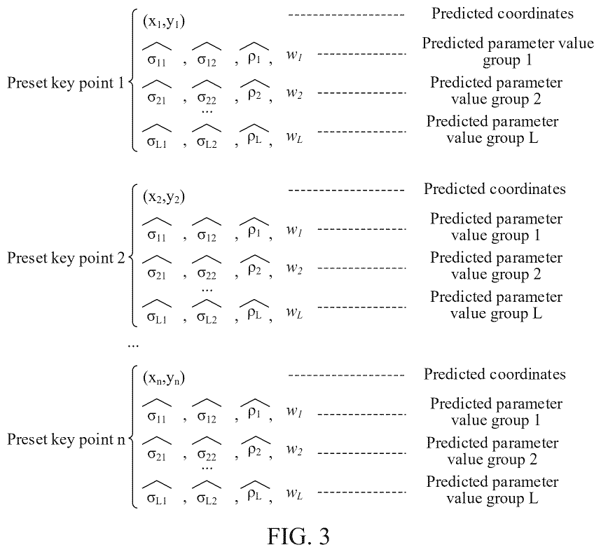

For example, with reference to FIG. 3, a schematic diagram of an outputted result of an initial pose estimation model in an embodiment of this application is shown in FIG. 3. Assuming that n denotes a total number of the preset key points, the preset distribution functions for each preset key point are L Gaussian distributions. As can be seen from contents illustrated in FIG. 3, for each preset key point, corresponding predicted coordinates and L groups of predicted parameter values may be obtained through the initial pose estimation model. A predicted parameter value group 1 corresponding to a preset key point 1 is taken as an example. The predicted parameter value group 1 includes parameter values { [symbol] , w₁}, [symbol] denotes the standard deviation on the horizontal axis, [symbol] denotes the standard deviation on the vertical axis, β₁ denotes the Pearson correlation coefficient determined, and w₁ denotes a component weight determined for a corresponding distribution function (for example, a Gaussian distribution 1 of the L Gaussian distributions).

The standard deviation is a measure of a degree of divergence of a mean of one group of data. A greater standard deviation indicates a bigger difference between most values and a mean of these values. A smaller standard deviation indicates that these values are closer to a mean. The Pearson correlation coefficient β₁ is configured for indicating the correlation between the standard deviation [symbol] on the horizontal axis and the standard deviation [symbol] on the vertical axis. Since each Gaussian distribution of the L Gaussian distributions may be deemed as one component, a weight of each Gaussian distribution is referred to as a component weight. Each Gaussian distribution is a probability density function. A covariance matrix of one Gaussian distribution (or referred to as a component distribution) is determined by a standard deviation on a horizontal axis and a standard deviation on a vertical axis that correspond to the Gaussian distribution, and a Pearson correlation coefficient jointly.

Operation 203: The treatment device performs the following operations for each preset key point: aggregate the L distribution functions based on the predicted coordinates and the L groups of predicted parameter values that correspond to the preset key point, to obtain a predicted probability distribution of the predicted key point in the sample image, and determine a distribution loss according to a distribution difference between the predicted probability distribution and a corresponding target probability distribution.

The predicted probability distribution is configured for describing a probability that each pixel point in the sample image is the preset key point. The predicted probability distribution of the preset key point in the sample image is a probability distribution determined with each pixel in the sample image as a predicted key point of the preset key point. In the embodiment of this application, assuming that the preset L distribution functions are specifically the L Gaussian distributions, in a process of determining a corresponding predicted probability distribution for each predicted key point, for each Gaussian distribution, the treatment device performs the following operations for each Gaussian distribution: determine a mean matrix of the Gaussian distribution based on predicted coordinates corresponding to the Gaussian distribution, determine a covariance matrix and a component weight of the Gaussian distribution based on one group of predicted parameter values corresponding to the Gaussian distribution, and obtain a Gaussian distribution result after the parameter assignment; and then, perform Gaussian mixture treatment on L Gaussian distribution results according to component weights determined for the L Gaussian distributions respectively, and obtain the predicted probability distribution of the corresponding predicted key point in the sample image.

Specifically, considering that in this application, for each preset key point, the probability (or referred to as a Gaussian mixture indication of the preset key point) that each pixel point in the sample image is the preset key point is determined by aggregating the Gaussian distributions after L parameter assignment, according to the actual treatment demand, the sample image may be a two-dimensional image. Thus, considering that a coordinate position of the pixel point in the sample image is two-dimensional, the L Gaussian distributions used are specifically L binary Gaussian distributions. In view of the above, in a process of concretizing the Gaussian distribution by performing the parameter assignment on each Gaussian distribution, the mean matrix and the covariance matrix of the Gaussian distribution may be determined for each Gaussian distribution. The mean matrix is, for example, a 1×2 matrix, and the covariance matrix is, for example, a 2×2 matrix.

When the L distribution functions are the L Gaussian distributions, each obtained group of predicted parameter values includes: a standard deviation on a horizontal axis, a standard deviation on a vertical axis, a Pearson correlation coefficient, and a component weight of a distribution function. Thus, when a mean matrix is determined for one Gaussian distribution, two coordinate values included in the predicted coordinates corresponding to the Gaussian distribution may be taken as two elements in the mean matrix. To be specific, the predicted coordinates are means of the Gaussian distribution. The covariance matrix of the Gaussian distribution may be determined according to a formula (1) as follows:

$$C = [ \begin{matrix}{2}^{} & \hat{ρ} \\ \hat{ρ} {\hat{σ}}_{1} & {2}^{}\end{matrix} ] \qquad formula ( 1 )$$

In the formula, [symbol] denotes the standard deviation on the horizontal axis included in one group of predicted parameter values corresponding to the Gaussian distribution, [symbol] denotes the standard deviation on the vertical axis included in the one group of predicted parameter values corresponding to the Gaussian distribution, \hat{ρ} denotes the Pearson correlation coefficient, \hat{ρ}∈(−1,1) denotes a value range, and C denotes the covariance matrix constructed.

For the L Gaussian distributions corresponding to one preset key point, L covariance matrices are constructed and denoted as

$${C}_{i} ∈ {ℝ}_{+}^{2 \times 2} , 0 < i \leq L ,$$

the covariance matrix of each Gaussian distribution being capable of being constructed according to the formula (1).

Based on the L Gaussian distributions, the way to jointly determine a final predicted probability distribution may be the Gaussian mixture distribution. The L Gaussian distributions may be L Gaussian components of the Gaussian mixture distribution. Parameters of the L Gaussian components are denoted as {(\hat{z}, Cᵢ, wᵢ)}, 0<i≤L. The L Gaussian distributions corresponding to one preset key point have the same mean matrix \hat{z}, and different covariance matrices and component weights.

Since the Gaussian mixture distribution obtained by aggregating a plurality of Gaussian distributions is not a standard Gaussian distribution, the standard deviation is not an accurate digit. It is difficult to describe the standard deviation according to a specific formula accurately when the standard deviation is predicted through the initial pose estimation model. To describe the standard deviation, in the embodiment of this application, the distribution is sampled through a Monte Carlo method, to obtain a distribution form. A basic operation step of the Monte Carlo method is to extract a required number of samples without acquiring the Gaussian mixture distribution, so that the samples conform to the Gaussian mixture distribution. Such a process is referred to as sampling for short. Through sampling, an approximate standard deviation of the Gaussian mixture distribution is obtained. For example, first, one distribution may be constructed to generate a large number of random digits as samples. Then, the samples are selected according to a particular method.

Further, for the L Gaussian distributions corresponding to each preset key point, parameter assignment is performed on the L Gaussian distributions separately. The parameter assignment involves the mean matrix and the covariance matrix. Then, weighted aggregation is performed on the L Gaussian distributions corresponding to one preset key point according to a component weight included in L groups of corresponding predicted parameter values, and a predicted probability distribution of a corresponding predicted key point in the sample image after the Gaussian mixture treatment is completed. A related process of mixture is shown according to a formula (2) as follows:

$${p}_{θ} ( q ) = {\sum }_{i = 1}^{L} \frac{{w}_{i}}{2 π \sqrt{\vert {C}_{i} \vert}} {e}^{( - \frac{1}{2} {( q - \hat{z} )}^{T} {C}_{i}^{- 1} ( q - \hat{z} ) )} \qquad formula ( 2 )$$

In the formula, pθ(x) denotes a Gaussian mixture indication (also referred to as a predicted probability distribution) obtained for one preset key point (assuming to be the preset key point 1), L denotes a total number of the preset Gaussian distributions, wᵢ denotes a component weight predicted by the initial pose estimation model for a Gaussian distribution i, Cᵢ denotes a covariance matrix determined for the Gaussian distribution i, \hat{z} denotes a mean matrix determined according to the predicted coordinates of the preset key point 1, and q, a variable, denotes a matrix determined according to coordinates of any pixel point in the sample image.

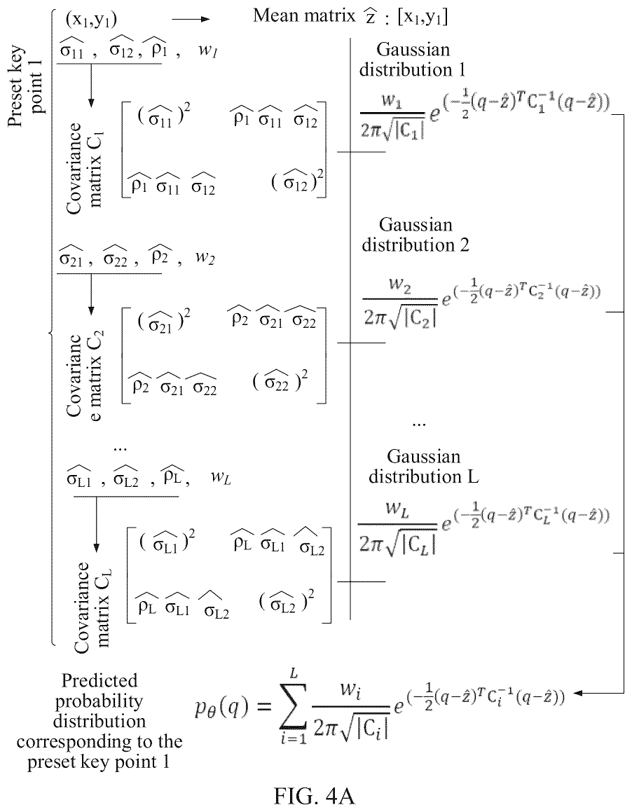

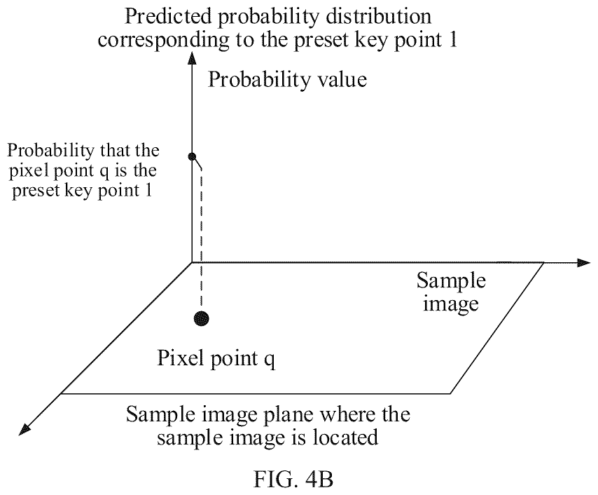

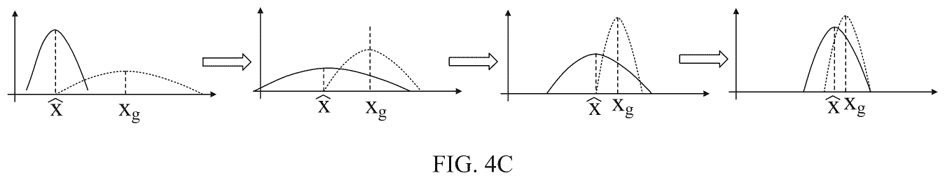

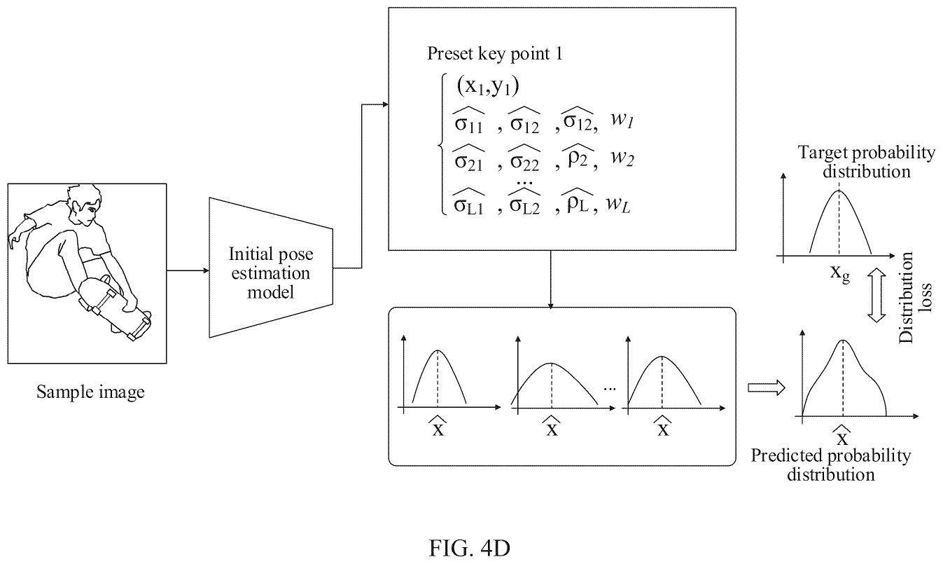

For example, with reference to FIG. 4A, a schematic diagram of a process of determining a corresponding predicted probability distribution for one preset key point in an embodiment of this application is shown in FIG. 4A. As can be seen from a treatment process illustrated in FIG. 4A, after the predicted coordinates and the L groups of predicted parameter values are determined in correspondence to one preset key point 1, a corresponding mean matrix may be determined based on the predicted coordinates, and a corresponding covariance matrix may be constructed based on parameter values in each group of predicted parameter values. Further, the L Gaussian distributions added with the component weights are specifically determined based on the mean matrix and L covariance matrices that are obtained. Then, the Gaussian distributions are added, and the predicted probability distribution corresponding to the preset key point 1 is obtained.

For another example, with reference to FIG. 4B, a schematic diagram of a mapping relationship between a predicted probability distribution and a sample image in an embodiment of this application is shown in FIG. 4B. As can be seen from contents illustrated in FIG. 4B, after the predicted probability distribution is obtained for the preset key point 1, a corresponding probability value may be determined for each pixel point in the sample image. The probability value determined is configured for indicating a probability that the pixel point is the preset key point 1. As can be seen from contents illustrated in FIG. 4B, for a pixel point q in one sample image, a two-dimensional matrix of the pixel point may be determined according to pixel coordinates of the pixel point q in the sample image. Further, one probability value of the pixel point q may be determined according to the formula (2).

In this way, a corresponding predicted probability distribution may be determined for each preset key point by virtue of the predicted coordinates and the L groups of predicted parameter values that are directly predicted by the initial pose estimation model. To be specific, a Gaussian mixture indication corresponding to each preset key point is determined. Coordinates of the preset key point may be converted into the probability distribution in an image space by virtue of the Gaussian mixture indication. Thus, constraint contents considered during training of a regression model and the inputted image are in the same spatial dimension, an expression capability of the model is improved, and better performance is obtained through model training.

Further, when the L distribution functions are specifically the L Gaussian distributions, and the target probability distribution is the Gaussian distribution, in a process of determining a corresponding target probability distribution for each preset key point, the treatment device may determine a target mean matrix based on sample coordinates of the preset key point, determine a standard deviation on each coordinate axis in the image coordinate system of the sample image, and determine a target covariance matrix of the target probability distribution according to the standard deviation on each coordinate axis. Then, the treatment device may perform parameter assignment on the standard Gaussian distribution based on the target mean matrix and the target covariance matrix, and obtain the target probability distribution. The target probability distribution is a probability distribution on the sample image and determined based on the sample coordinates of the preset key point. The target probability distribution is described relative to the predicted probability distribution, and is a target that the predicted probability distribution needs to approach. The “target mean matrix” is one mean matrix, and the “target covariance matrix” is one covariance matrix. The target mean matrix and the target covariance matrix are named because they are the mean matrix and the covariance matrix of the “target” probability distribution respectively.

The above process of determining the target probability distribution is described below with the target probability distribution being constructed for one preset key point (assuming to be the preset key point 1) as an example.

For example, the target probability distribution may be constructed through the standard Gaussian distribution. The standard Gaussian distribution used is specifically a binary standard Gaussian distribution, and the standard deviation on the horizontal axis and the standard deviation on the vertical axis are set as the same value. The standard Gaussian distribution is shown as follows:

$$f ( x ) = \frac{1}{\sqrt{2 π} σ} exp ( - \frac{{( x - μ )}^{2}}{2 {σ}^{2}} )$$

In the formula, u denotes an expected value (a mean), and ø denotes a standard deviation.

When the target mean matrix is determined, a horizontal coordinate value and a vertical coordinate value included in the sample coordinates of the preset key point 1 are determined as elements in the target mean matrix. The coordinate dimension of the sample coordinates is identical to a number of elements in the target mean matrix. For example, assuming that sample coordinates of one preset key point are (10, 25), the target mean matrix determined in correspondence to the preset key point is [10, 25]. In a process of determining the corresponding target covariance matrix for the preset key point 1, the standard deviation on the horizontal coordinate axis and the standard deviation on the vertical coordinate axis may be first determined. According to the actual treatment demand, the standard deviation on each coordinate axis may be a set fixed value. Alternatively, the standard deviation on each coordinate axis may dynamically change with a difference between the predicted coordinates and the sample coordinates of the preset key point. The standard deviations on the coordinate axes are set as the same value. The foregoing L Gaussian distributions may also be constructed based on the binary standard Gaussian distribution.

With reference to FIG. 4C, a schematic diagram of dynamic adjustment of a target probability distribution in an embodiment of this application is shown in FIG. 4C. As can be seen from contents illustrated in FIG. 4C, an overall distribution change is intuitively illustrated in a form of a graph with one-dimensional variables in FIG. 4C. The graph with one-dimensional variables may be extended to a graph with two-dimensional variables. In FIG. 4C, \hat{X} denotes a mean in a one-dimensional graph of a schematic predicted probability distribution, and x_{g} denotes a mean in a one-dimensional graph of a schematic target probability distribution.

As can be seen from the dynamic change process of the predicted probability distribution and the target probability distribution illustrated in FIG. 4C, with the progress of training, \hat{X} is set to gradually approaches x_{g}. Then, at an initial training stage, to make the target probability distribution intersect with the Gaussian mixture indication (or referred to as the predicted probability distribution) to the greatest extent, so that the target probability distribution can effectively take a role when the parameter is adjusted based on the distribution difference, the value of the standard deviation may be adjusted step by step, to obtain a dynamic target probability distribution.

In view of the above, since the target probability distribution is the Gaussian distribution, the treatment device may control the standard deviation of the target Gaussian distribution by multiplying a difference between the predicted coordinates and the sample coordinates by a particular coefficient. For example, the treatment device may determine a norm value indicating the difference between the sample coordinates and the predicted coordinates based on the sample coordinates and the predicted coordinates of the predicted key point, determine, when it is determined that the norm value exceeds a set threshold, the norm value as the standard deviation on each coordinate axis of the target probability distribution, and determine, when it is determined that the norm value does not exceed a set threshold, the set threshold as the standard deviation on each coordinate axis of the target probability distribution, the standard deviation on each coordinate axis of the target probability distribution being set as the same value.

For example, assuming that a denotes a set coefficient, the standard deviation σ_{g} of the target Gaussian distribution is calculated according to a formula (3) as follows:

$${σ}_{g} = α ‖ \hat{z} - {q}_{g} ‖ \qquad formula ( 3 )$$

In the formula, \hat{z} denotes the predicted coordinate of one preset key point, q_{g} denotes the sample coordinates of the preset key point, and ∥\hat{z}−q_{g}∥ denotes a norm of a two-dimensional result obtained by acquiring the difference between the predicted coordinates and the sample coordinates.

However, if the standard deviation of the target Gaussian distribution changes continuously, the predicted probability distribution cannot achieve the convergence target, which is not conducive to convergence determination in a process of model training. Also, since the predicted probability distribution fits the target probability distribution in shape through an L1 loss term of the distribution loss in the process of training, the predicted probability distribution cannot learn useful shape information through one target probability distribution that changes all the time. The L1 loss term will be described in detail in the subsequent process of calculating a model loss. In view of the above, when the target probability distribution converges to a particular state, the target probability distribution stops changing and remains unchanged. Assuming that t denotes a standard deviation threshold corresponding to the state, the target probability distribution is calculated according to a formula (4) as follows:

$${p}_{g} ( q ) = 𝒩 ( {q}_{g} , {σ}_{g} ) , \{ \begin{matrix}{σ}_{g} = α ‖ \hat{z} - {q}_{g} ‖ , & α ‖ \hat{z} - {q}_{g} ‖ > t \\ {σ}_{g} = t , & α ‖ \hat{z} - {q}_{g} ‖ \leq t\end{matrix} \qquad formula ( 4 )$$

In the formula, p_{g}(q) denotes a target probability distribution of one preset key point on the sample image, \hat{z} denotes predicted coordinates determined based on the preset key point, q_{g} denotes sample coordinate determined based on the preset key point, σ_{g} denotes a standard deviation determined for the preset key point, and a value of t is determined according to the actual treatment demand.

In this way, in the process of model training, the value of the standard deviation may be dynamically determined based on the difference between the predicted coordinates and the sample coordinates. Thus, the target probability distribution can intersect with the predicted probability distribution to the greatest extent, and the action of the distribution loss determined based on the target probability distribution and the predicted probability distribution can be better exerted in the process of model training.

Then, after the standard deviation on the horizontal axis and the standard deviation on the vertical axis are determined, a target covariance matrix is obtained according to a formula (5) as follows:

$${C}_{target} = [ \begin{matrix}{2}^{} & 0 \\ 0 & {2}^{}\end{matrix} ] \qquad formula ( 5 )$$

In the formula, C_{target} denotes the target covariance matrix calculated, [symbol] denotes the standard deviation on the horizontal axis, and [symbol] denotes the standard deviation on the vertical axis.

Further, after parameter assignment is performed on the standard Gaussian distribution based on the target mean matrix obtained and the target covariance matrix obtained, the target probability distribution corresponding to the preset key point 1 is obtained.

In this way, based on the sample coordinates corresponding to the preset key point, the target probability distribution with a maximum probability value at the sample coordinates is established in the sample image space, which provides a comparison basis for the predicted probability distribution created for a model prediction result.

Further, after the treatment device determines the corresponding predicted probability distribution and target probability distribution for each preset key point, the corresponding distribution loss may be calculated according to a formula as follows:

$${ℒ}_{dist} = {D}_{KL} ( {p}_{g} ‖ {p}_{θ} ) + γ {‖ {p}_{g} , {p}_{θ} ‖}_{1} \qquad formula ( 6 )$$

In the formula, [symbol] _{dist} denotes the distribution loss, p_{g} denotes the target probability distribution, pe denotes the predicted probability distribution, D_{KL}(p_{g}∥p_{θ}) denotes a Kullback-Leibler (KL) divergence between the predicted probability distribution and the target probability distribution, ∥p_{g}, θₑ∥₁, denotes an L1 loss between the target probability distribution and the predicted probability distribution, γ denotes a smoothing coefficient configured for smoothing two loss sub-terms, and a specific value of the smoothing coefficient is set according to the actual treatment demand.

In the embodiments of this application, since a value of the KL divergence has instability, especially exhibits particular fluctuations at a zero probability density of the distribution, an additional L1 loss term may be added based on calculation of the KL divergence when the distribution loss is determined.

Before adjusting the model parameter of the initial pose estimation model based on the distribution loss determined for each preset key point, the treatment device may perform the following operations for each preset key point: calculate a position (pixel position) loss based on a difference between the predicted coordinates and the sample coordinates that correspond to each preset key point.

Specifically, the position loss may be calculated according to a formula (7) as follows:

$${ℒ}_{reg} = {‖ \hat{z} - {q}_{g} ‖}_{1} \qquad formula ( 7 )$$

In the formula, [symbol] _{reg} denotes a position loss determined in correspondence to one preset key point, \hat{z} denotes the predicted coordinates of the preset key point, q_{g} denotes the sample coordinates of the preset key point, and ∥ ∥₁ denotes acquisition of the L1 loss.

In this way, by calculating the difference between the predicted coordinates and the sample coordinates, the position loss is obtained. Thus, the impact of a regression loss of a regression model itself can be retained in a model loss calculated, to constrain a coordinate regression value.

Operation 204: The treatment device adjusts the model parameter of the initial pose estimation model based on each distribution loss.

In a feasible embodiment of this application, when operation 204 is performed, the treatment device may adjust the model parameter of the initial pose estimation model according to the distribution loss determined in correspondence to each preset key point.

In some other feasible embodiments, when the position loss is introduced, in a process of adjusting the model parameter, the model parameter of the initial pose estimation model may be adjusted based on each distribution loss and each position loss, and a final loss function is shown according to a formula (8) as follows:

$$ℒ OSS = {ℒ}_{dist} + {λℒ}_{reg} \qquad formula ( 8 )$$

In the formula, [symbol] oss denotes a loss value finally determined for one preset key point, [symbol] dist denotes a distribution loss calculated for the preset key point, [symbol] _{reg} denotes a position loss (also referred to as a regression loss, denoting a loss generated when the initial pose estimation model predicts a position of the preset key point in the sample image) calculated for the preset key point, and λ denotes a position loss coefficient. In this way, at the initial model training stage, no overlapping region between two distributions due to a too long distance between the predicted probability distribution and the target probability distribution can be avoided. Further, no change of the distribution loss in the absence of the overlapping region between the two distributions can be avoided. Moreover, by introducing the position loss, it can be ensured that the model is fitted to an initial convergence state as soon as possible, so that training efficiency of the initial pose estimation model is improved.

With reference to FIG. 4D, a schematic diagram of a process of calculating a model loss for a preset key point in an embodiment of this application is shown in FIG. 4D. As can be seen from contents illustrated in FIG. 4D, after the sample image is inputted into the initial pose estimation model, the predicted coordinates and the L groups of predicted parameter values that are outputted by the model for the preset key point 1 are obtained. Further, for the preset key point 1, the parameter assignment is performed on the preset L Gaussian distributions separately, and the Gaussian mixture treatment is performed to obtain the corresponding predicted probability distribution. For ease of intuitive understanding, the schematic diagram of the Gaussian distribution in FIG. 4D is a schematic diagram under the one-dimensional variables. Further, the distribution loss is determined with reference to a difference between the predicted probability distribution and the corresponding target probability distribution that are obtained for the preset key point 1.

Operation 205: The treatment device determines whether a model convergence condition is satisfied, and if yes, performs operation 206, otherwise, returns to perform operation 202.

In the embodiments of this application, the preset convergence condition may be as follows: a total number of training rounds reaches a first threshold, or a number of times that a model loss calculated during a plurality of rounds of model training is continuously less than a second threshold reaches a third threshold. Values of the first threshold, the second threshold, and the third threshold are set according to the actual treatment demand.

Operation 206: The treatment device outputs a trained target pose estimation model.

Specifically, the treatment device iteratively performs a training process illustrated in operations 202 to 204 for the initial pose estimation model, until the preset convergence condition is satisfied, so that the trained target pose estimation model is obtained.

Further, the treatment device may perform service treatment in different service scenarios according to the target pose estimation model obtained.

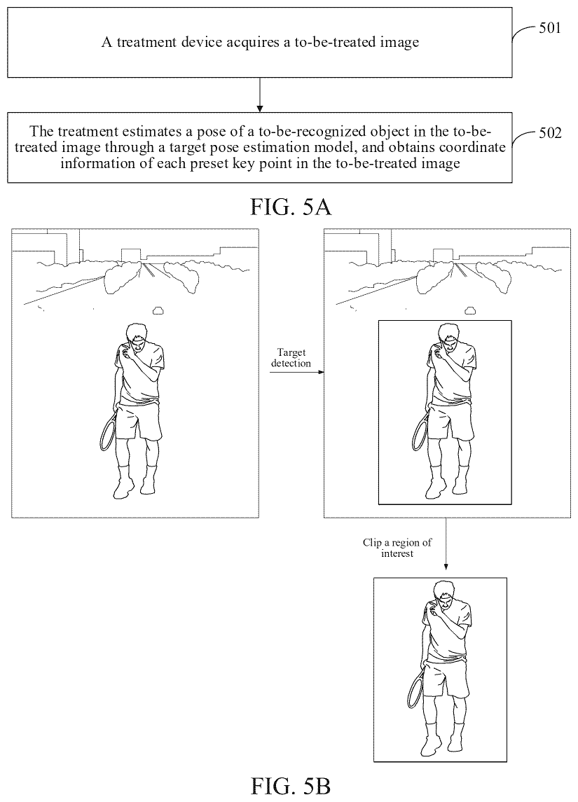

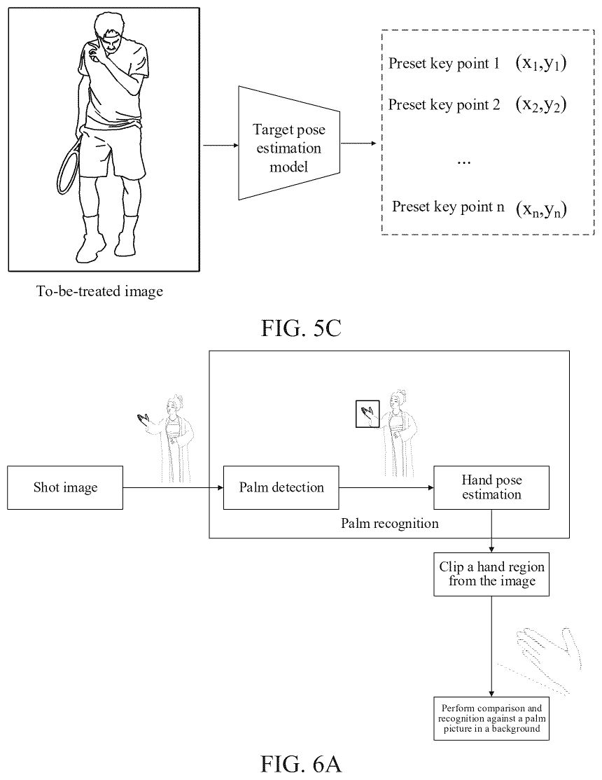

With reference to FIG. 5A, a schematic diagram of a process of implementing service treatment by virtue of a target pose estimation model in an embodiment of this application is shown in FIG. 5A. The process of service treatment through the target pose estimation model is described below with reference to FIG. 5A.

Operation 501: The treatment device acquires a to-be-treated image.

In a feasible implementation of this application, the treatment device may acquire the to-be-treated image collected by an image collection device, or may acquire the to-be-treated image selected by a related person from the client device. The to-be-treated image is an image for pose estimation.

In some other feasible implementations, to reduce treatment pressure of the target pose estimation model, the to-be-treated image may be clipped from an original image acquired. For example, after acquiring the original image, the treatment device recognizes an object in the original image, and determines a target region encompassing a to-be-recognized object in the original image. The to-be-recognized object is an object targeted by pose estimation. Then, the treatment device clips an image content corresponding to the target region from the original image, to obtain the to-be-treated image.

For example, with reference to FIG. 5B, a schematic diagram of a process of obtaining a to-be-treated image through arrangement in an embodiment of this application is shown in FIG. 5B. As can be seen from contents illustrated in FIG. 5B, when a pose of a “person” is estimated, after acquiring the original image, the treatment device may perform target detection on the original image according to the actual pose estimation demand, and marks a physical region or a local physical region targeted by the pose estimation in a form of a target detection frame. A detection method used in a process of target detection may be a general-purpose physical region detection method (for example, a you look only once (YOLO) algorithm) or a local physical region detection method. Then, the treatment device clips the region (marked as a region of interest) marked with the target detection box from the original image as input of the target pose estimation model. In the embodiments of this application, a process of clipping the to-be-treated image from the original image is also applicable to generation of the sample image at the model training stage. In this way, the region of interest is clipped from the original image, so that in the to-be-treated image obtained, interference caused by introducing background contents can be avoided to the greatest extent, and an effect of estimating the pose of the specified object can be ensured.

Operation 502: The treatment device estimates a pose of the to-be-recognized object in the to-be-treated image through the target pose estimation model, and obtains coordinate information of each preset key point in the to-be-treated image.

The treatment device inputs the to-be-treated image into the target pose estimation model, and obtains predicted coordinate information corresponding to each preset key point after the pose is estimated.

For example, with reference to FIG. 5C, a schematic diagram of a process of estimating a pose in an embodiment of this application is shown in FIG. 5C. As can be seen from contents illustrated in FIG. 5C, the treatment device inputs the to-be-treated image into the target pose estimation model, and obtains predicted coordinates outputted by the target pose estimation model and corresponding to each preset key point.

In this way, in a process of specifically executing the pose estimation task, it is not required to determine the predicted probability distribution for each preset key point, and a process of determining the predicted probability distribution may be stopped at the model training stage. A function of calculating the predicted probability distribution based on model output may be deemed as one plug-in subsequent to the pose estimation model. Thus, when treatment is performed based on the trained target pose estimation model, a related plug-in may be directly removed without being involved in overall time consumption. This does not bring a resource occupation burden to an application process of the model while improving an effect of model training, so that high efficiency of the pose estimation is ensured.

Further, after obtaining the coordinate information of each preset key point in the to-be-treated image, the treatment device may determine a state feature of the to-be-recognized object in the to-be-treated image based on a position relationship between the coordinate information; and determine a target state matching the to-be-recognized object based on a matching condition between the state feature and a candidate state feature corresponding to each candidate state.

In the embodiments of this application, a candidate state feature corresponding to each candidate state may be pre-stored. Each candidate state may be selected from the following types of states: different body poses, different gestures, and different object identity authentication states. When the candidate poses are different body poses or different gestures, the candidate state feature pre-stored may indicate a relative position of each preset key point under a corresponding pose or gesture. When the candidate state indicates the identity authentication state, the candidate state feature may be specifically a feature configured for implementing identity authentication, such as a palmprint feature and an iris feature.

In view of the above, the treatment device may determine the state feature of the to-be-recognized object according to the position relationship between the preset key points, and further determine the target state corresponding to the to-be-recognized object according to the state feature. The to-be-recognized object indicates an object targeted by the pose estimation in the to-be-treated image.

In this way, by virtue of a pose estimation result, the state of the to-be-recognized object may be determined in various application scenarios.

The involved process of service treatment is described below with reference to the accompanying drawings with several types of service treatment performed by applying the target pose estimation model as an example.

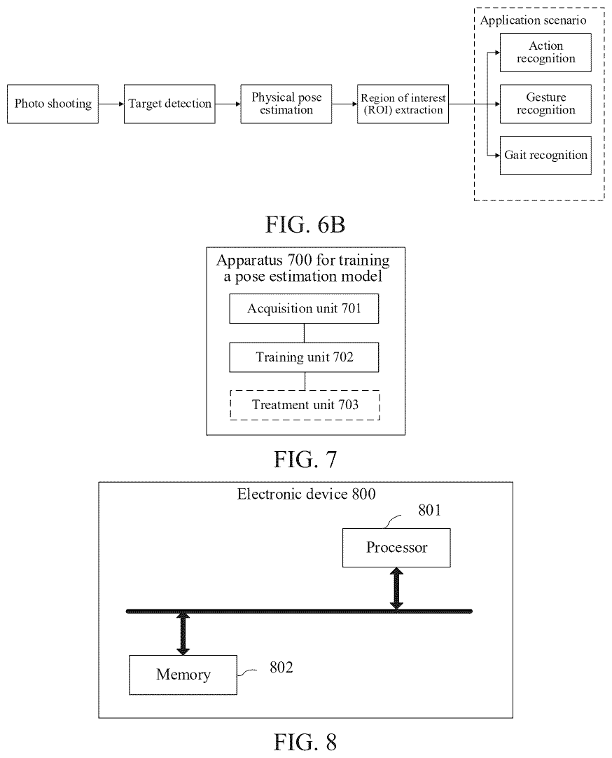

With reference to FIG. 6A, a schematic diagram of a flow of palmprint recognition in an embodiment of this application is shown in FIG. 6A. A process of implementing palmprint recognition based on the target pose estimation model is described below with reference to FIG. 6A.

As people pay more attention to privacy, the palmprint recognition has a wider application prospect in actual application scenarios such as payment and identity authentication. The physical pose estimation technology according to the embodiments of this application may be applied to a hand of a person, and configured for detecting a hand key point in an image collected in real time, to complete location of a palm region.

Specifically, before a palmprint of each user is recognized, a palm recognition component may be formed by a palm detection model and a palm key point detection model (i.e. the target pose estimation model) applying the physical pose estimation technology jointly, and the palm of the user is registered in a background registration library.

Then, in each process of recognition, after a shot image is acquired, palm detection and hand pose estimation treatment are performed on the shot image in sequence. Finally, the hand region is determined in the image and clipped from the image. Further, palmprint recognition and comparison between an image of the hand region and each photo in the registration library are performed, to identify an identity of the user, so that identity authentication is completed. After the palm detection, the hand region can be approximately determined in the image. After the hand pose estimation treatment, a position of each preset key point of the hand can be determined, so that the hand region can be accurately located.

With reference to FIG. 6B, a schematic diagram of treatment logic during action recognition by virtue of a target pose estimation model in an embodiment of this application is shown in FIG. 6B. The physical pose estimation provided by this application may be applied to recognition of actions, gestures, and gaits, for example, determination of falling and a disease signal, and automatic teaching of fitness, sports, and dances. As can be seen from contents illustrated FIG. 6B, in a process of recognizing the action, the gesture, and the gait, the treatment logic involved is as follows: a physical body or a hand region is located through target detection after an image is shot. Then, physical pose estimation is implemented through the target pose estimation model, and preset key points of the physical body or the hand are located. Further, a region of interest (ROI) is extracted according to each preset key point determined, and subsequent recognition of the action, the gesture, and the gait is completed according to the determined region of interest.

Also, the applicant obtains the following comparison result by comparing the pose estimation method conceived of at the inventive concept stage with the pose estimation method provided by this application.

Specifically, with reference to Table 1, comparisons of model test effects in the embodiments of this application are shown in Table 1. The applicant tests treatment effects of the pose estimation method provided by this application and other feasible pose estimation methods on a verification set of a public data set Microsoft common objects in context (MSCOCO). Indicators for evaluating the treatment effects include: a parameter quantity, Giga floating-point operations per second (GFLOPs), and mean average precision (mAP). The parameter quantity and the GFLOPs denote model treatment speeds. The smaller the parameter quantity and the GFLOPs are, the higher the model treatment speed is. The mAP indicates accuracy of model prediction. The greater the mAP is, the more accurate the model prediction is.

TABLE 1

| | | | Parameter | | |
|---|---|---|---|---|---|
| | | Inputted | Quantity | | mAP |
| Method | Backbone | size | (M) | GFLOPs | (%) |
| Simple | Residual | 256 × 192 | 34.0 | 8.90 | 70.4 |
| Baselines | Neural | | | | |
| | Network-50 | | | | |
| | (ResNet-50) | | | | |
| Simple | ResNet-152 | 256 × 192 | 68.6 | 15.70 | 72.0 |
| Baselines | | | | | |
| Pose | ResNet-50 | 256 × 192 | 41.5 | 5.45 | 63.7 |
| Recognition | | | | | |
| with Cascase | | | | | |
| Transformers | | | | | |
| (PRTR) | | | | | |
| PRTR | High- | 256 × 192 | 57.2 | 10.23 | 72.9 |
| | Resolution | | | | |
| | Network- | | | | |
| | W32 | | | | |
| | (HRNet-W32) | | | | |
| PRTR | HRNet-W32 | 512 × 384 | 57.2 | 37.80 | 73.3 |
| Run Length | ResNet-50 | 256 × 192 | 23.6 | 4.04 | 70.5 |
| Encoding | | | | | |
| (RLE) | | | | | |
| RLE | HRNet-W48 | 256 × 192 | 75.6 | 15.76 | 74.2 |
| Simple | ResNet-50 | 256 × 192 | 25.7 | 3.80 | 70.8 |
| Coordinate | | | | | |
| Classifi- | | | | | |
| cation | | | | | |
| (SimCC) | | | | | |
| DistilPose-S | Stemnet | 256 × 192 | 5.4 | 2.38 | 71.6 |
| DistilPose-L | HRNet-W48 | 256 × 192 | 21.3 | 10.33 | 74.4 |
| Ours | Stemnet | 256 × 192 | 5.4 | 2.44 | 71.8 |
| (constant-gt) | | | | | |
| Ours | Stemnet | 256 × 192 | 5.4 | 2.44 | 72.8 |
| (variable-gt) | | | | | |
| Ours | HRNet-W48 | 256 × 192 | 21.3 | 10.40 | 75.0 |
| (variable-gt) | | | | | |

The ResNet-50 and the Stemnet are smaller backbones, and the ResNet-152 and the HRNet are larger backbones. A greater W coefficient of the HRNet indicates deeper and wider network layers of the HRNet and a larger model. Comparatively, the ResNet-50 is greater than the Stemnet, and the HRNet-W32 and the ResNet-152 are approximately the same in size.

In conclusion, when compared with other pose estimation methods under the backbones of the same grade, the performance of the target pose estimation model obtained through training based on the model training method provided by this application can be superior to the performance of all other methods, and the parameter quantity and the GFLOPS can be maintained within small ranges. The treatment performance of this application is better than that of SimpleBaselines, a heatmap model. Thus, the target pose estimation model obtained through training based on the training method provided by this application has significant treatment advantages that are far superior to those of other current feasible methods.

In this way, based on the method for training a pose estimation model provided by this application, learning of the regression model (i.e. the initial pose estimation model) can be promoted to achieve the performance comparable to that of the heatmap model while time consumption is added to the lowest extent. Moreover, this application is low in time cost, and thus is applicable to a real-time physical pose estimation scenario. Comprehensively, this application creatively provides the training method. The position of the preset key point is indicated by virtue of the Gaussian mixture treatment, and the difference between the predicted probability distribution and the target probability distribution is minimized through the Monte Carlo estimation, so that model training is completed.

Based on the same inventive concept, with reference to FIG. 7, a schematic structural diagram of logic of an apparatus for training a pose estimation model in an embodiment of this application is shown in FIG. 7. The apparatus 700 for training a pose estimation model includes an acquisition unit 701 and a training unit 702.

According to one embodiment of this application, the acquisition unit 701 may be configured to acquire a training sample, the training sample including a sample image and first coordinates of a preset key point in the sample image, and the preset key point being configured for locating a pose of an object in the sample image.

The training unit 702 may be configured to estimate the pose of the object in the sample image through an initial pose estimation model, to obtain predicted second coordinates of the preset key point in the sample image and L groups of predicted parameter values, the L groups of predicted parameter values being determined for preset L distribution functions respectively; aggregate the L distribution functions based on the predicted second coordinates and the L groups of predicted parameter values, to obtain a predicted probability distribution, and determine a distribution loss according to a difference between the predicted probability distribution and a target probability distribution, the predicted probability distribution denoting a probability distribution that each predicted pixel point in the sample image is the preset key point, and the target probability distribution being a probability distribution determined based on the first coordinates; and adjust a model parameter of the initial pose estimation model based on the distribution loss, to obtain a target pose estimation model.

The training unit 702 may be configured to perform parameter assignment and weighted summation on the L distribution functions based on the predicted second coordinates and the L groups of predicted parameter values, to obtain the predicted probability distribution.

The training unit 702 may be configured to perform parameter assignment on each distribution function corresponding to the L distribution functions based on the predicted second coordinates and a predicted function parameter value in each group of predicted parameter values of the L groups of predicted parameter values, and obtain L distribution function results; and take the L distribution function results as components, and perform weighted summation on the L distribution function results through a component weight of the L groups of predicted parameter values, to obtain the predicted probability distribution.

When the preset L distribution functions are L Gaussian distributions, the training unit may be configured to determine a mean matrix of each Gaussian distribution of the L Gaussian distributions based on the predicted second coordinates, determine a covariance matrix and a component weight of the Gaussian distribution based on one group of predicted parameter values corresponding to the Gaussian distribution, and obtain a Gaussian distribution result after the parameter assignment; and perform Gaussian mixture treatment on the L Gaussian distribution results according to component weights determined for the L Gaussian distributions respectively, to obtain the predicted probability distribution.

The target probability distribution is one Gaussian distribution and is determined in the following mode: determine a target mean matrix based on the first coordinates, determine a standard deviation on a horizontal coordinate axis and a standard deviation on a vertical coordinate axis in an image coordinate system respectively, and determine a target covariance matrix of the target probability distribution according to the standard deviation on the horizontal coordinate axis and the standard deviation on the vertical coordinate axis; and perform parameter assignment on a standard Gaussian distribution based on the target mean matrix and the target covariance matrix, and obtain the target probability distribution.

During the determining of the standard deviation on each corresponding coordinate axis, the training unit 702 is configured to determine, based on the first coordinates and the predicted second coordinates, a norm value indicating a difference between the first coordinates and the predicted second coordinates; and determine, when it is determined that the norm value exceeds a set threshold, the norm value as the standard deviation on the horizontal coordinate axis and the standard deviation on the vertical coordinate axis of the target probability distribution, and determine, when it is determined that the norm value does not exceed a set threshold, the set threshold as the standard deviation on the horizontal coordinate axis and the standard deviation on the vertical coordinate axis of the target probability distribution, the standard deviation on the horizontal coordinate axis and the standard deviation on the vertical coordinate axis of the target probability distribution being set as the same value.

According to another embodiment of this application, the acquisition unit 701 may be configured to acquire each training sample. One training sample includes one sample image and sample coordinates of each preset key point in one sample image. Each preset key point is configured for locating a pose.

The training unit 702 is configured to perform a plurality of rounds of iterative training on an initial pose estimation model based on each training sample, and obtain a target pose estimation model. In one round of iterative training, operations are performed as follows:
perform pose estimation on a sample image encompassed in a selected training sample, and obtain, through regression treatment, predicted coordinates and L groups of predicted parameter values that correspond to each preset key point, the L groups of predicted parameter values being determined for preset L distribution functions respectively.

For each preset key point, operations are performed as follows: the training unit 702 aggregates the L distribution functions based on the predicted coordinates and the L groups of predicted parameter values that correspond to the preset key point, to obtain a predicted probability distribution of a corresponding predicted key point in the sample image, and determines a distribution loss according to a distribution difference between the predicted probability distribution and a corresponding target probability distribution. The target probability distribution is a probability distribution on the sample image and determined based on the first coordinates of the preset key point. The training unit 702 adjusts a model parameter of the initial pose estimation model based on each distribution loss.

The preset L distribution functions are L Gaussian distributions. During aggregating of the L distribution functions based on the corresponding predicted coordinates and the L groups of predicted parameter values, to obtain a predicted probability distribution of a corresponding predicted key point in the sample image, the training unit 702 is configured to:
perform the following operations for each Gaussian distribution: determine a mean matrix of the Gaussian distribution based on the corresponding predicted coordinates, determine a covariance matrix and a component weight that correspond to the Gaussian distribution based on one corresponding group of predicted parameter values, and obtain a Gaussian distribution result after the parameter assignment; and
perform Gaussian mixture treatment on L Gaussian distribution results according to component weights determined for the L Gaussian distributions respectively, and obtain the predicted probability distribution of the corresponding predicted key point in the sample image.

The target probability distribution may be a Gaussian distribution and is determined in the following mode:
determine a target mean matrix based on sample coordinates of the corresponding preset key point, determine a standard deviation on each corresponding coordinate axis, and determine a target covariance matrix corresponding to the target probability distribution according to the standard deviation on each coordinate axis; and
perform parameter assignment on a standard Gaussian distribution based on the target mean matrix and the target covariance matrix, and obtain the target probability distribution.

During the determining of the standard deviation on each corresponding coordinate axis, the training unit 702 may be configured to:
determine, based on the sample coordinates and the predicted coordinates of the predicted key point, a norm value indicating a difference between the sample coordinates and the predicted coordinates; and
determine, when it is determined that the norm value exceeds a set threshold, the norm value as the standard deviation on each coordinate axis of the target probability distribution, and determine, when it is determined that the norm value does not exceed a set threshold, the set threshold as the standard deviation on each coordinate axis of the target probability distribution, the standard deviation on each coordinate axis of the target probability distribution being set as the same value.

Before the adjusting of the model parameter of the initial pose estimation model based on each distribution loss, the training unit 702 may be further configured to:
perform the following operations for each preset key point: calculate a position loss based on the difference between the corresponding predicted coordinates and the sample coordinates.

The adjusting of the model parameter of the initial pose estimation model based on each distribution loss includes:
adjust the model parameter of the initial pose estimation model based on each distribution loss and each position loss.

After the target pose estimation model is obtained, the apparatus may further include a treatment unit 703. The treatment unit 703 may be configured to:
acquire a to-be-treated image; and
estimate a pose of a to-be-recognized object in the to-be-treated image through the target pose estimation model, and obtain coordinate information of each preset key point in the to-be-treated image.

During the acquiring of the to-be-treated image, the treatment unit 703 may be configured to:
acquire an original image;
recognize an object in the original image, and determine a target region encompassing the to-be-recognized object in the original image, the to-be-recognized object being an object targeted by pose estimation; and
clip an image content corresponding to the target region from the original image, and obtain the to-be-treated image.

After the obtaining of the coordinate information of each preset key point in the to-be-treated image, the treatment unit 703 may be further configured to:
determine a state feature of the to-be-recognized object in the to-be-treated image based on a position relationship between the coordinate information; and
determine a target state matching the to-be-recognized object based on a matching condition between the state feature and a candidate state feature corresponding to each candidate state.

Reference can be made to the descriptions in the method embodiments for details of the above apparatus for training a pose estimation model in the embodiment of this application.

After the method and apparatus for training a pose estimation model in the exemplary implementations of this application are described, an electronic device according to another exemplary implementation of this application is described below.

Those skilled in the art can understand that various aspects of this application can be implemented as a system, a method, or a program product. Thus, various aspects of this application can be specifically implemented in the following forms, i.e. full hardware implementations, full software implementations (including firmware, microcodes, etc.), or hardware and software combined implementations, which can be collectively referred to as a “circuit”, a “module”, or a “system” herein.

Based on the same inventive concept as that in the above method embodiment, when the electronic device in the embodiment of this application corresponds to the treatment device, with reference to FIG. 8, a schematic structural diagram of hardware components of an electronic device in an embodiment of this application is shown in FIG. 8. The electronic device 800 may include at least a processor 801 and a memory 802. The memory 802 has a computer program stored therein, the computer program, when executed by the processor 801, causing the processor 801 to perform operations of training any pose estimation model described above.

In some possible implementations, the electronic device according to this application may include at least one processor and at least one memory. The memory has a computer program stored therein, the computer program, when executed by the processor, causing the processor to perform operations of training the pose estimation models according to various exemplary implementations of this application in the description. For example, the processor may perform operations as shown in FIG. 2A and FIG. 2B.

Based on the same inventive concept as that in the above method embodiment, various aspects of training the pose estimation model provided by this application may alternatively be implemented in a form of a program product. The program product includes program codes. When the program product is run in the electronic device, the program codes are configured for causing the electronic device to perform operations of training the pose estimation models according to various exemplary implementations of this application in the description. For example, the electronic device may perform operations as shown in FIG. 2A and FIG. 2B.

The program product may use one or any combination of more of readable media. The readable medium may be a readable signal medium or a readable storage medium. The readable storage medium may be, for example, but is not limited to, an electric, magnetic, optical, electromagnetic, infrared, or semiconductive system, apparatus, or device, or any combinations of the above. More specific examples (a non-exhaustive list) of the readable storage medium include an electrical connection having one or more wires, a portable disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any appropriate combinations of the above.

Although the embodiments of this application have been described, those skilled in the art can make other changes and modifications to these embodiments once they learn the basic creative concept. Thus, the appended claims are intended to be interpreted as including the embodiments and all changes and modifications falling within the scope of this application.

It is clear that those skilled in the art can make various modifications and variations to this application without departing from the spirit and scope of this application. Thus, if these modifications and variations made to this application fall within the scope of the claims of this application and their equivalent technologies, this application is intended to include these modifications and variations.

What is claimed is:

1. A method for training a pose estimation model performed by an electronic device, the method comprising:
acquiring a sample image and first coordinates of a preset key point in the sample image, and the preset key point being configured for locating a pose of an object in the sample image;
estimating the pose of the object in the sample image through an initial pose estimation model, to obtain predicted second coordinates of the preset key point in the sample image and L groups of predicted parameter values for preset L distribution functions respectively;
aggregating the L distribution functions based on the predicted second coordinates and the L groups of predicted parameter values, to obtain a predicted probability distribution that a predicted pixel point in the sample image is the preset key point;
determining a distribution loss according to a difference between the predicted probability distribution and a target probability distribution based on the first coordinates; and
adjusting a model parameter of the initial pose estimation model based on the distribution loss, to obtain a target pose estimation model.

2. The method according to claim 1, wherein the aggregating comprises:
performing parameter assignment and weighted summation on the L distribution functions based on the predicted second coordinates and the L groups of predicted parameter values, to obtain the predicted probability distribution.

3. The method according to claim 1, wherein the aggregating comprises:
performing parameter assignment on each distribution function corresponding to the L distribution functions based on the predicted second coordinates and a predicted function parameter value in each group of predicted parameter values of the L groups of predicted parameter values to obtain L distribution function results; and
performing weighted summation on the L distribution function results through a component weight of the L groups of predicted parameter values, to obtain the predicted probability distribution.

4. The method according to claim 1, wherein the preset L distribution functions are L Gaussian distributions; and
the aggregating comprises:
determining a mean matrix of each Gaussian distribution of the L Gaussian distributions based on the predicted second coordinates, determining a covariance matrix and a component weight of the Gaussian distribution based on one group of predicted parameter values corresponding to the Gaussian distribution, and obtaining a Gaussian distribution result after the parameter assignment; and
performing Gaussian mixture treatment on the L Gaussian distribution results according to component weights determined for the L Gaussian distributions respectively, to obtain the predicted probability distribution.

5. The method according to claim 1, wherein the target probability distribution is determined by:
determining a target mean matrix based on the first coordinates, determining a standard deviation on a horizontal coordinate axis and a standard deviation on a vertical coordinate axis in an image coordinate system respectively, and determining a target covariance matrix of the target probability distribution according to the standard deviation on the horizontal coordinate axis and the standard deviation on the vertical coordinate axis; and
performing parameter assignment on a standard Gaussian distribution based on the target mean matrix and the target covariance matrix, and obtaining the target probability distribution.

6. The method according to claim 1, wherein the adjusting the model parameter of the initial pose estimation model based on the distribution loss further comprises:
calculating a position loss based on the difference between the predicted second coordinates and the first coordinates, the position loss denoting a loss predicted by the initial pose estimation model for a coordinate position of the preset key point in the sample image; and
adjusting the model parameter of the initial pose estimation model based on the distribution loss and the position loss.

7. The method according to claim 1, wherein the initial pose estimation model comprises a backbone and a prediction end, the prediction end comprising multiple linear layers; and
the estimating the pose of the object in the sample image through an initial pose estimation model comprises:
extracting a feature from the sample image through the backbone; and
performing regression treatment on the feature extracted through the linear layer, and predicting the second coordinates and the L groups of predicted parameter values.

8. The method according to claim 1, wherein the method further comprises:
acquiring a target image; and
estimating a pose of a target object in the target image through the target pose estimation model; and
obtaining coordinate information of the preset key point in the target image.

9. The method according to claim 8, wherein the acquiring the target image comprises:
acquiring an original image;
determining a target region encompassing the target object in the original image; and
clipping an image content corresponding to the target region from the original image, and obtaining the target image.

10. The method according to claim 8, wherein after the obtaining coordinate information of the preset key point in the target image, the method further comprises:
determining a state feature of the target object in the target image based on a position relationship between the coordinate information; and
determining a target state matching the target object based on a matching condition between the state feature and a candidate state feature corresponding to each candidate state.

11. An electronic device, comprising a memory, a processor, and a computer program stored in the memory and runnable in the processor, the computer program, when executed by the processor, causing the electronic device to implement a method for training a pose estimation model including:
acquiring a sample image and first coordinates of a preset key point in the sample image, and the preset key point being configured for locating a pose of an object in the sample image;
estimating the pose of the object in the sample image through an initial pose estimation model, to obtain predicted second coordinates of the preset key point in the sample image and L groups of predicted parameter values for preset L distribution functions respectively;
aggregating the L distribution functions based on the predicted second coordinates and the L groups of predicted parameter values, to obtain a predicted probability distribution that a predicted pixel point in the sample image is the preset key point;
determining a distribution loss according to a difference between the predicted probability distribution and a target probability distribution based on the first coordinates; and
adjusting a model parameter of the initial pose estimation model based on the distribution loss, to obtain a target pose estimation model.

12. The electronic device according to claim 11, wherein the aggregating comprises:
performing parameter assignment and weighted summation on the L distribution functions based on the predicted second coordinates and the L groups of predicted parameter values, to obtain the predicted probability distribution.

13. The electronic device according to claim 11, wherein the aggregating comprises:
performing parameter assignment on each distribution function corresponding to the L distribution functions based on the predicted second coordinates and a predicted function parameter value in each group of predicted parameter values of the L groups of predicted parameter values to obtain L distribution function results; and
performing weighted summation on the L distribution function results through a component weight of the L groups of predicted parameter values, to obtain the predicted probability distribution.

14. The electronic device according to claim 11, wherein the preset L distribution functions are L Gaussian distributions; and
the aggregating comprises:
determining a mean matrix of each Gaussian distribution of the L Gaussian distributions based on the predicted second coordinates, determining a covariance matrix and a component weight of the Gaussian distribution based on one group of predicted parameter values corresponding to the Gaussian distribution, and obtaining a Gaussian distribution result after the parameter assignment; and
performing Gaussian mixture treatment on the L Gaussian distribution results according to component weights determined for the L Gaussian distributions respectively, to obtain the predicted probability distribution.

15. The electronic device according to claim 11, wherein the target probability distribution is determined by:
determining a target mean matrix based on the first coordinates, determining a standard deviation on a horizontal coordinate axis and a standard deviation on a vertical coordinate axis in an image coordinate system respectively, and determining a target covariance matrix of the target probability distribution according to the standard deviation on the horizontal coordinate axis and the standard deviation on the vertical coordinate axis; and
performing parameter assignment on a standard Gaussian distribution based on the target mean matrix and the target covariance matrix, and obtaining the target probability distribution.

16. The electronic device according to claim 11, wherein the adjusting the model parameter of the initial pose estimation model based on the distribution loss further comprises:
calculating a position loss based on the difference between the predicted second coordinates and the first coordinates, the position loss denoting a loss predicted by the initial pose estimation model for a coordinate position of the preset key point in the sample image; and
adjusting the model parameter of the initial pose estimation model based on the distribution loss and the position loss.

17. The electronic device according to claim 11, wherein the initial pose estimation model comprises a backbone and a prediction end, the prediction end comprising multiple linear layers; and
the estimating the pose of the object in the sample image through an initial pose estimation model comprises:
extracting a feature from the sample image through the backbone; and
performing regression treatment on the feature extracted through the linear layer, and predicting the second coordinates and the L groups of predicted parameter values.

18. The electronic device according to claim 11, wherein the method further comprises:
acquiring a target image; and
estimating a pose of a target object in the target image through the target pose estimation model; and
obtaining coordinate information of the preset key point in the target image.

19. The electronic device according to claim 18, wherein after the obtaining coordinate information of the preset key point in the target image, the method further comprises:
determining a state feature of the target object in the target image based on a position relationship between the coordinate information; and
determining a target state matching the target object based on a matching condition between the state feature and a candidate state feature corresponding to each candidate state.

20. A non-transitory computer-readable storage medium, having a computer program stored therein, the computer program, when executed by a processor of an electronic device, causing the electronic device to implement a method for training a pose estimation model including:
acquiring a sample image and first coordinates of a preset key point in the sample image, and the preset key point being configured for locating a pose of an object in the sample image;
estimating the pose of the object in the sample image through an initial pose estimation model, to obtain predicted second coordinates of the preset key point in the sample image and L groups of predicted parameter values for preset L distribution functions respectively;
aggregating the L distribution functions based on the predicted second coordinates and the L groups of predicted parameter values, to obtain a predicted probability distribution that a predicted pixel point in the sample image is the preset key point;
determining a distribution loss according to a difference between the predicted probability distribution and a target probability distribution based on the first coordinates; and
adjusting a model parameter of the initial pose estimation model based on the distribution loss, to obtain a target pose estimation model.
